(19) United States
(12) Patent Application Publication
(10) Pub. No.: US 2010/0091478 A1
(43) Pub. Date: Apr. 15, 2010

(54) Chemiluminescent aerosol spray

(76) Inventor: Harris Richard Miller, Sharon, MA (US)

Correspondence Address: LAMBERT & ASSOCIATES, P.L.L.C., 92 STATE STREET, BOSTON, MA, 02109-2004, US

(21) Appl. No.: 12/287,653

(22) Filed: Oct. 14, 2008

(51) Int. Cl. F21K 2/06

(52) U.S. Cl. 362/34

(57) ABSTRACT

This invention relates to a stable, multiple-use chemiluminescent marking system capable of articulating, communicating, displaying and conveying chemiluminescent messages in the form of written text, numerics, alpha-numerics, figures, drawings, emergency messages, distress calls or directional traffic indicators. The invention functions by co-dispensing two vessels, each of which are pressurized by means of a liquid miscible propellant. The chemical ingredients from each vessel are combined by means of a mixing valve attached to the actuators of each vessel, which simultaneously eject the contents of both vessels and produce a ballistic chemiluminescent aerosol spray. In another aspect of this invention, each vessel has an internal pressure of 1 atmosphere and an aerosol spray is produced by a hand or finger-actuated co-dispensing pump spray.

### BACKGROUND OF THE INVENTION

1. Field of the Invention

The invention relates to a stable, multiple use, chemiluminescent marking system capable of articulating, communicating, displaying or conveying chemiluminescent messages in the form of written text, numerics, alpha-numerics, figures, drawings, emergency messages, distress calls or directional traffic indicators.

2. Brief Description of Art

Chemiluminescence is a well known and established phenomenon, dating back as far as 1928 with the discovery of 3-aminophthalhydrazide, a.k.a. Luminol (U.S. Pat No. 3,597,362). Similar to chemiluminescence, bioluminescence is ubiquitous in nature and can be found in a wide variety of algae and insects. The many uses of chemiluminescence and bioluminescence are widespread and span from applications of biological identification to general illumination. Commercial examples of modern-day chemiluminescent illumination are commonly produced using a small, flexible tubular housing comprised of two liquids in two separate compartments. Light energy is generated when the first, inner compartment is fractured, which mixes the contents with the second, outer compartment. Such a device, known as a “light-stick”, has found widespread use in many emergency, military and even novelty applications.

Notwithstanding the success of light-sticks and the great progress in their increased luminous intensity, their use as a source of illumination is very limited. Because the luminous intensity of light-sticks cannot compare with that of a household incandescent light bulb and because of the inverse square law for light intensity (which decreases proportionally to the square of the distance), the light intensity generated from a chemiluminescent light-stick is insufficient to illuminate even the smallest rooms, areas, scenes or objects. However, because luminance (the light that an observer sees when looking directly at a light source) is invariant with distance, the light-stick appears very bright to the observer even when looking directly at the chemiluminescent light-stick source at a distance. Thus the light stick is much more useful as a ruminant signaling or marking device than as a source of illumination, reflecting on an impinged object. Therefore, chemiluminescent light-sticks are best applied to situations where the observer can look directly at the chemiluminescent source as a type of signal, marker or indicator.

One disadvantage of chemiluminescent light-sticks is that they are single-use. Once the two components are mixed and the chemiluminescent reaction has begun, the reaction proceeds to completion. The light-stick cannot be re-used or re-started for a second use and must be discarded. Yet another disadvantage of the light stick is the waste generated from the disposal of the chemical light devices; for example, many of the light-sticks used for marine applications are thrown overboard and later wash up on beaches.

Solving the problem of a single-use chemiluminescent marker, which is discarded after only one use is therefore, very desirable. One method of producing a multiple-use chemiluminescent, biodegradable marking device is to comprise a mixture of a chemiluminescent compound together with a liquefied gas. Such a mixture of chemiluminescent ingredient and propellant can be stable under pressure and once released to the atmosphere, reacts with the oxygen in the air to produce a chemiluminescent light. Such a mixture can be released by means of an exploding or fused frangible disk for single-use, or released by means of a spring-loaded nozzle and spray actuator for multiple-use.

The type of compounds known to produce chemiluminescence upon contact with air or oxygen, are called oxyluminescent. The class of oxyluminescent compounds is called peraminoethylenes and one example of a suitable peraminoethylene is known as tetrakis(dimethylamino)ethylene (TMAE). Such a chemiluminescent spray formulation is disclosed in U.S. Pat. No. 3,697,434, whose use is claimed for nighttime sea or land rescue markers.

However, peraminoethylene, and specifically TMAE, is flammable and produces a highly flammable vapor. TMAE is also a safety hazard, which is corrosive and can be very destructive to human mucous membranes. Furthermore, TMAE has an unpleasant amine odor. All of these properties of oxyluminescent compounds, such as TMAE, make it too dangerous for consumer applications. Therefore, a multiple-use chemiluminescent, biodegradable marking device, for consumer applications, is very desirable.

Because of the safety hazards associated with oxyluminescent compounds, two-part chemical systems have dominated both commercial and military chemiluminescent devices. For two-part chemiluminescent systems, the first part usually consists of a fluorescer and the second part consists of an activator. Such a two-part system is the basis of the pre-described light-stick. However, all two-part chemiluminescent devices can be used only once and then must be discarded. This is because the chemical activation of the fluorescer is accomplished by fracturing the inner compartment of a tubular housing, which combines the two reactants and thus creating the chemiluminescence.

U.S. Pat. No. 3,612,857 describes a location marker, which uses the same chemical activation method, namely fracturing an inner compartment, but also ejecting a strip of cloth saturated with a chemiluminescent material when activated by a firing pin, which detonates and ignites a gas-generating pellet. In this single-use chemiluminescent marker configuration, a piston within the device ejects the chemically saturated cloth and activated mixture of chemicals, to produce a chemiluminescent reaction.

U.S. Pat. No. 3,584,211 describes yet another chemiluminescent device utilizing a rupturable pod, or inner compartment, in which the contents may be dispensed or poured onto a surface by means of opening a screw cap closure. However, this design reflects yet another a single-use chemiluminescent design and once the reaction is initiated, the chemiluminescent reaction cannot be stopped, re-started or used at a later date.

Another marker system is described in U.S. Pat. No. 3,940,605, which is a two-part chemiluminescent marking system activated by generating an explosive gas by a frangible means or an explosive actuator to trigger the mixing and eject the two parts; namely the fluorescer and activator. Such a system is capable of marking an intended area by ejecting the entire contents of the two-part chemiluminescent by a percussive explosion, spreading the activated chemiluminescent reactants into an open area. Yet another two-part, single-use, chemiluminescent marking system (U.S. Pat. No. 4,682,544) employs a fuse or percussive cap to release a fluorescer, activator and propellant. Such a system has been found useful in bomb simulation exercises for military training exercises. However, the ability of a chemiluminescent marking system capable of multiple uses is still highly desirable. Furthermore, a chemiluminescent system capable of directing the reacted components such that an articulated message can be conveyed is also highly desirable.

### SUMMARY OF THE INVENTION

The invention, as illustrated herein, is clearly not anticipated, rendered obvious, or even present in any of the prior art mechanisms, either alone or in any combination thereof. A versatile chemiluminescent aerosol spray mechanism and accompanying method, which can be quickly installed or removed and adapts to differing conditions to protect said container, adapted to compensate for the aforementioned drawbacks and limitations would afford significant improvement to numerous useful applications. Thus, the invention as illustrated herein, is clearly not anticipated, rendered obvious, or even present in any of the prior art mechanisms, either alone or in any combination thereof. Thus the several embodiments of the instant invention are illustrated herein.

In accordance with one embodiment, this invention relates to a binary composition of two fluids in two separate chambers comprising a first fluid in the first chamber consisting of a chemiluminescent fluorescer fluid and having a dispensing outlet controlled by a first valve and a second fluid in the second chamber consisting of a chemiluminescent activator fluid and having a dispensing outlet controlled by a second valve different from the first valve, and an actuator connected to each of the first and second valves; which simultaneously co-dispenses both fluids from the separate chambers, initiating a chemiluminescent reaction in a fine stream.

In one aspect, the invention relates to a chemiluminescent marking system capable of articulating, communicating, displaying or conveying chemiluminescent messages in the form of written text, numerics, alpha-numerics, figures, drawings, emergency messages, distress calls or directional traffic indicators.

Yet another embodiment of this invention is to produce a ballistic chemiluminescent aerosol spray composition consisting of two parts, with each part consisting of a container having an internal pressure of 1 atmosphere and which a ballistic, chemiluminescent aerosol spray is produced by a hand or finger-actuated co-dispensing pump spray. Each of these components for the chemiluminescent, aerosol marker systems will be discussed in more detail.

In another aspect, this invention relates to a composition comprised of two chambers, with each chamber containing a dispensing a valve, and which each valve is connected to an actuator which simultaneously co-dispenses and mixes the fluids from each of the two chambers thereafter expelling the contents of the two chambers to produce a chemiluminescent fluid mixture.

In another of its aspects, this invention relates to a binary chemiluminescent system consisting of a fluorescer and an activator; wherein the contents of each chamber is released from the action of a dual-mechanical, co-dispensing push-button pump.

In another of its aspects, this invention relates to co-dispensing a binary chemiluminescent system consisting of a fluorescer and an activator; wherein each chamber is pressurized with a compressed liquid gas propellant and which the mixture of fluorescer and activator are expelled to produce a ballistic chemiluminescent aerosol spray.

In another of its aspects, this invention relates to co-dispensing a binary chemiluminescent system wherein the expelled composition of fluorescer and activator contains another component for altering the viscosity or viscoelastic properties of the ejected material, such as to produce a chemiluminescent foam, gel, cream, lotion or paint

In yet another of its aspects, this invention relates to a liquid chemiluminescent marker or writing instrument, particularly of the felt tip type, having a bifurcated reservoir containing fluorescer and activator. The cylindrical body supports the writing tip, which communicates with the fluorescer and activator writing fluids. The fluids are expelled and co-dispensed from the chambers by means of gravity and capillary action to produce a chemiluminescent marking.

There has thus been outlined, rather broadly, the more important features of the versatile system in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention may be better understood after reading the following detailed description of non-limiting embodiments and upon examining the accompanying drawings, in which:

FIG. 1 is a diagrammatic axial section view of the device showing a dual-dispense chemiluminescent aerosol spray can.

FIG. 1A is a diagrammatic axial section view of the device showing a dual-dispense chemiluminescent aerosol spray can mixing chamber shown in FIG. 1.

FIG. 2 is a diagrammatic axial section view of the device showing a dual-dispense chemiluminescent push button spray bottle.

FIG. 3 is a perspective view of a liquid chemiluminescent marker of the present invention.

FIG. 3A is a close up view of a dual wick dispenser for a chemiluminescent marker with a recessed barrier shown in FIG. 3.

FIG. 3B is a close up view of a dual wick dispenser for a chemiluminescent marker with barrier being fully extended to the felt tip shown in FIG. 3.

FIG. 4 is a cross sectional view of the separate fluorescer and oxidizer compartments of the chemiluminescent marker shown in FIG. 3.

### DETAILED DESCRIPTION OF THE DRAWINGS

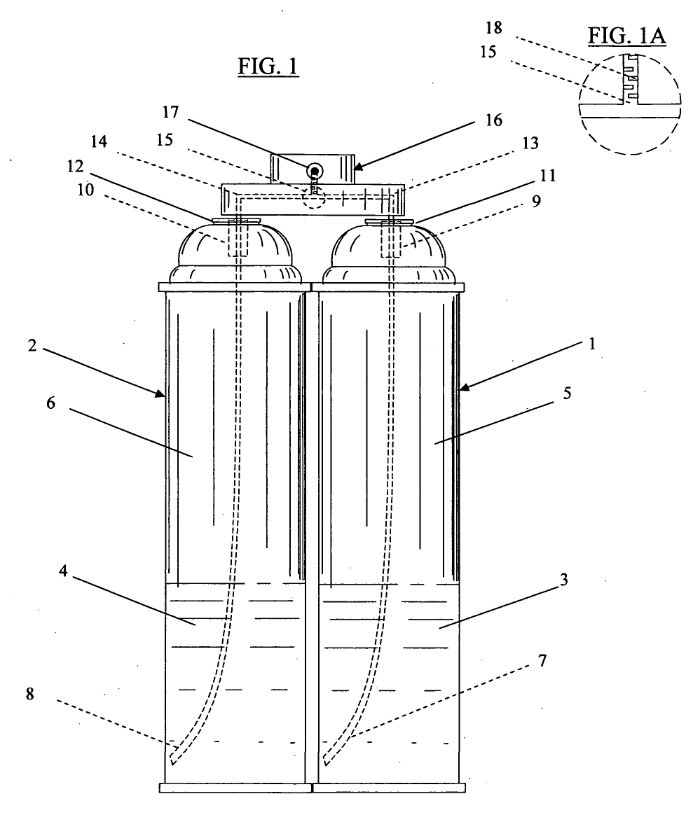

The preferred embodiments of the present invention will be described with reference to FIGS. 1-5 of the drawings. FIG. 1 is the first exemplary embodiment of a device for ejecting a chemiluminescent spray by means of a co-dispensed ballistic aerosol spray. The device comprises a first can 1, which may be made out of steel or aluminum and a second can 2, which may also be made from steel, aluminum or some other suitable material. Each of the cans 1,2 respectively defines a first reservoir 3, containing a liquid fluorescent dye and the second reservoir 4, containing a liquid oxidizer. Once filled with the chemiluminescent liquid formulations 3, 4 the first can 1 is sealed with cap 11 and the second can 2 is sealed with cap 12. Each of the cans liquids 1,2 are pressurized by propellant gases 5,6, such as 1,1,1,2-tetrafluoroethane or dimethyl ether, which are miscible in the chemiluminescent fluid but do not react and which can be injected directly through the actuators 9,10 and through the dip tubes 7,8. The device further comprises a combination nozzle and mixing valve 16, such that when valve 16 is depressed, actuator valves 9,10 open and allow chemiluminescent liquids 3,4 to escape through dip tubes 7,8, and into the nozzle channels 13,14. The two, co-dispensed, chemiluminescent liquids are then combined at the mixing chamber 15 and subsequently ejected through outlet 17. FIG. 1A shows the mixing chamber 15 and mixing elements 18 which functions by converting the laminar flow through the nozzles 13,14 into turbulent flow thus mixing the two chemiluminescent components.

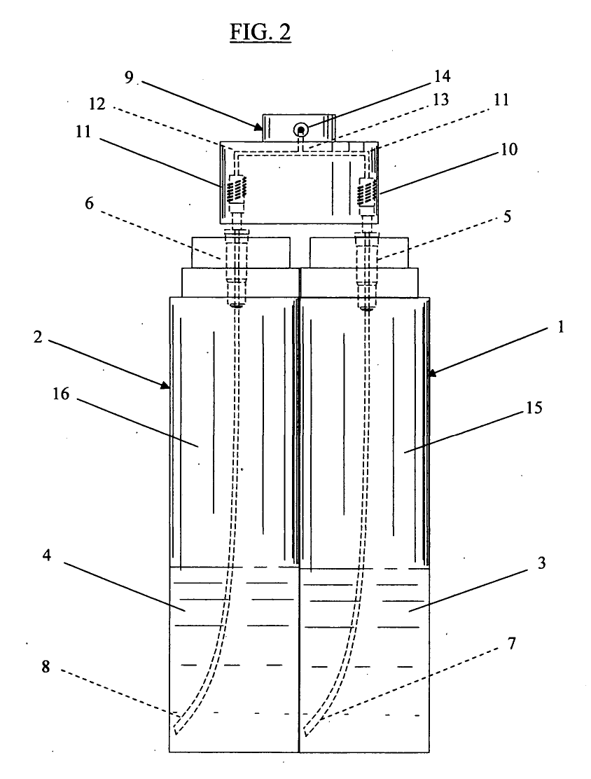

FIG. 2 is an exemplary embodiment of a device for ejecting a chemiluminescent spray by means of an aerosol spray pump. The device comprises a first vessel 1, which may be made from an elastically deformable plastic material, such as styrene ethylene butadiene, and a second interlocking vessel 2, which may also be made out of the same plastic. Each of the vessels 1,2 respectively define a first reservoir 3, containing a liquid fluorescent dye and the second reservoir 4, containing a liquid oxidizer. Once filled with the chemiluminescent liquid formulations 3,4 the first can is sealed with the pump valve 5 and the second vessel is filled with the pump valve 6. The containers sealed by pump valves 5,6 are preferably hermetic at standard temperature and pressure. Since the pump valves 5,6 do not pressurize vessels 1,2, any gas 15,16 such as air may be present. Push button 9 is movable relative to the base portions 1,2. Once push button 9 is depressed, pumps 5,6 dispense the chemiluminescent liquids 3,4 through the diptubes 7,8 and into the nozzle channels 11,12. The two, co-dispensed, chemiluminescent liquids are then combined at the mixing chamber 13 and subsequently ejected through outlet 14. The pumps 5,6 are returned to their ready position by means of helical springs 10,11.

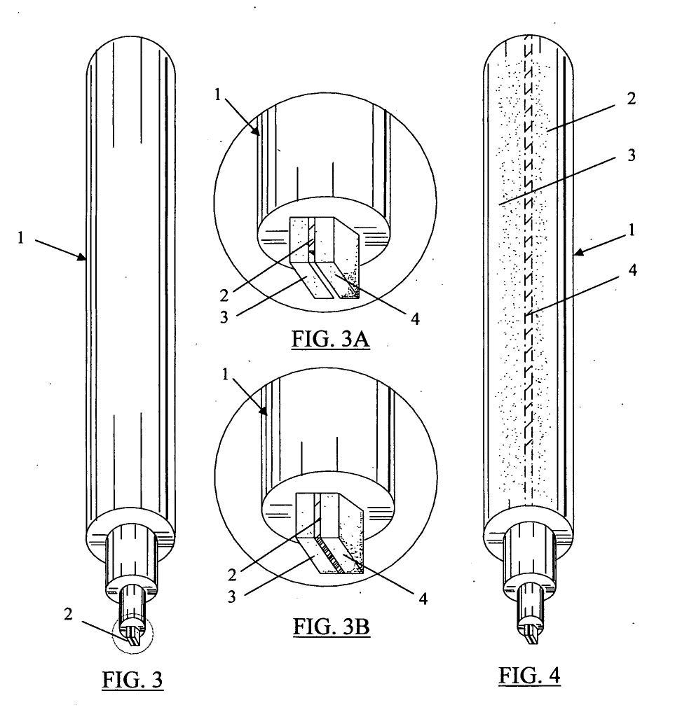

FIG. 3 describes an exemplary embodiment of a device for producing a chemiluminescent mark by means of a co-dispensed liquid marking instrument. Such a marking instrument consists of a hollow tubular sleeve 1 and a dual felt wick tip 2 located coaxially and at the end of the marker. The hollow tubular sleeve 1 is designed for manual gripping and for containing the chemiluminescent liquids. FIG. 3A describes a close-up view of the felt tip, bifurcated by barrier 2, which may be made out of polyethylene or some other chemical resistant element. The bifurcated felt tips 3,4 and barrier 2 are fastened to a smaller diameter hollow barrel sleeve 1. FIG. 3A shows a felt tip with a recessed barrier element 2. FIG. 3B describes yet another exemplary embodiment of the device in which the divider 2, extends fully to the same length as the felt tips. Controlling the extent to which the chemiluminescent felt tips are separated, either by an air gap or by the barrier element, serves to maximize the chemical mixing on the substrate to be marked.

As further shown in FIG. 4, the hollow tube 1 contains two separate reservoirs 2,3 which are separated by a barrier element 4. Typically, the first reservoir containing a liquid fluorescent dye 3, and the second reservoir containing a liquid oxidizer 4 such that the two chemiluminescent fluids are not mixed until they come in contact with the substrate. The chemiluminescent liquids advance out of the felt tip and to the substrate by means of capillary action. No internal pressure or means of expelling the chemiluminescent ingredients are required other than the pressure of the felt tips with the substrate to be marked.

Naturally, the invention is not limited to the embodiments described above and various modifications to the devices described above are fully contemplated. Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements maybe devised without departing from the scope of the present invention.

### DETAILED DESCRIPTION OF THE INVENTION

(1) Aerosol Spray Systems

The present invention relates to a composition of two separate fluids, which are ejected through a mixing chamber, either by pump action or by means of a ballistic aerosol spray; upon which the combined fluids produce chemiluminescent radiation. The chemiluminescent radiation can be in the range of 400-700 nm and hence visible to the naked eye and present itself in the form of a color or emit light across the entire visible spectrum and appear white. Alternatively, said radiation can be outside the visible spectrum and produce chemiluminescent radiation in the infra-red regions with a peak intensity of approximately 790 nm or in the or ultra-violet region with a peak intensity of approximately 365 nm.

A bifurcated or dual-chambered system, capable of simultaneously co-dispensing both fluids, is preferred for producing a stable composition. By spraying or ejecting the combined chemical formulations onto a common object, such as an automobile windshield, roadway or field, the chemiluminescent formulation produces sufficient luminance to be detected at a distance.

Furthermore, by incorporating a polymeric resin, such as polyhydroxystyrene, polyvinyl alcohol, carboxymethylcellulose or some other viscous thickening agent into the chemiluminescent formulation, the viscosity can be increased to approximately 500 centipoise or more. Such an increase in viscosity allows for the ejected chemiluminescent mixture to remain at the point of contact on the sprayed surface and allow for written text, numerics, alpha-numerics, figures, drawings, directions, emergency messages, distress calls or other conveyances to be created.

Since only a portion of the composition is ejected onto the substrate during use, the invention is capable of re-releasing the same components once re-actuated. The mixed and activated chemiluminescent composition does not form a precipitate in the mixing valve, maintaining a clear path for the next actuation. Because the system remains clear after use, a pump spray or aerosol spray, can be actuated numerous times until the chemiluminescent contents or propellant is consumed. Thus a completely re-usable, night-time signaling tool is created.

By combining the features of multiple use, high viscosity and long shelf life, a chemiluminescent spray expands its utility to -become a practical and sophisticated signaling device, capable of communicating a wide variety of text messages, signal indicators, graphic icons and emergency messages.

Normally, luminous intensity, peak intensity, duration and dominant wavelength (or color) are some of the principal considerations given to chemiluminescent systems. However, because the materials are ejected, special consideration had to be given to the environmental impact. Therefore, a non-flammable, biodegradable spray marker was produced, by formulating an aqueous composition for co-dispensing with a finger-actuated spray pump.

One preferred fluorescer commonly used for aqueous, alkaline chemiluminescent systems is known as 3-aminophthalhydrazide (Luminol). The solubility of Luminol is limited in water, so the amount of Luminol is not critical for producing a strong chemiluminescent reaction. The Luminol can be pre-dissolved in a miscible. organic solvent, such as an alcohol, ether or glycol before mixing into the aqueous alkaline part A, which can increase the duration of the chemiluminescent illumination. The ruminant intensity can be increased by increasing the amount of copper sulfate pentahydrate catalyst, which is incorporated into the part A composition together with the fluorescer and alkali. Part B is the activator solution, which is comprised of a dilute solution of hydrogen peroxide. The concentration of peroxide is not critical and does not impact either the luminous intensity or duration of the chemical reaction.

Therefore, by formulating an aqueous chemiluminescent composition; a safe, non-flammable, biodegradable chemiluminescent marker can be produced. However, for increased luminous intensity and longer chemiluminescent duration, a class of fluorescer dyes, known as anthracene solubilized in dibutyl phthalate is preferred.

The dominant wavelength, peak emission, or color of the chemiluminescence can be altered by the choice of fluorescing dye. The extent of the color change spans the entire visible wavelength and into the infra-red region depending on the choice of fluorescing dye used. The emission spectrum of the chemiluminescent reaction can be broadened by the incorporation of more than one fluorescer dye. This results in the emission of more than one wavelength of light, giving the appearance of a white-light emission spectrum. For an efficient blue-light chemiluminescent emission, the preferred fluorescer dye is 9,10-diphenylanthracene. For producing a yellow chemiluminescent emission, 1-chloro-9,10-bis(phenyethynyl)anthracene is preferred and for a near white-light emission, the combination of 9,20-diphenylanthracene and 1-chloro-9,10-bis(phenyethynyl)anthracene is preferred.

The dominant wavelength of the chemiluminescent spectral emission can be shifted out of the visible spectrum and into the near infra-red spectrum, producing an invisible chemiluminescent radiant flux. Such an infra-red radiant, chemiluminescent aerosol marker is useful for producing, covert text or graphical messages detectable only by infra-red sensors or detectors. The preferred fluorescer dye for an infra-red peak emission of 790 nm is 16,17-didecyloxyviolanthrone (See “Development of High Radiation Output Infrared Chemiluminescent Systems”, Mohan et. Al, Defense Technical Information Center, August 1979).

As indicated above, the present invention is directed to a binary chemiluminescent fluorescing dye, solvent and miscible propellant, while the second part comprises an oxidizer composition, composition consisting of two parts, wherein the first part contains of at least a solvent and miscible propellant; wherein the two separate parts are simultaneously co-dispensed through adjoined actuator valves and from which the individual parts are combined through a common mixing valve.

The preferred method of dispensing is to produce a ballistic, chemiluminescent aerosol spray with each part consisting of a container having an internal pressure of greater than 1 atmosphere, capable of forming a ballistic, chemiluminescent aerosol spray onto a surface or substrate.

### (2) Chemical Composition

There are a wide number of components that can be chosen to produce a chemiluminescent reaction. The selection of these components and their concentrations in the formulation can influence the emission spectrum, light intensity and reaction duration. Some of the chemical ingredients that control these chemiluminescent properties are the oxalate, fluorescent dye, and catalyst structures. The concentration of these chemical ingredients can also have an impact on the chemiluminescence. Likewise, the concentration of hydrogen peroxide (H₂O₂), also known as the reactant or oxidizer, as well as the choice of solvents, has an impact on the performance of the chemiluminescent chemical composition.

The preferred class of oxalates contains a carbalkoxy substituent in the ortho position to the phenolic oxygen. One preferred oxalate is bis(2-carbopentyloxy-3,5,6-trichlorophenyl)oxalate or bis(2,4,5-tricholoro-6-carbopentoxy)oxalate (CPPO). Another preferred oxalate is bis(2,4,5-trichloro-6-carbobutoxyphenyl)oxalate (TCCPO). Yet another preferred oxalate compound is bis(2,4,6-trichlorophenyl)oxalate (TCPO). The oxalate concentration can vary from 0.01 moles/liter (M) to 1.5 M, but the preferred concentration is 0.03 M to 0.03 M.

Many fluorescent compounds fall into the above criteria, however a second performance criteria is that the fluorescent compound must not readily react with peroxides, such as hydrogen peroxide or with esters of oxalic acid. A preferred fluorescent compound is one which has a spectral emission in the ultra violet (UV), visible or infra-red (IR) regions or has a dominant wavelength emission between 350 to 1200 Ångstroms. The preferred list of conjugated, polycyclic aromatic compounds, having at least 3 contiguous rings includes: anthracene, benzanthracene, phenanthrene, paphthacene, pentacene or perlylene. The preferred fluorescers include: 9,10-diphenylanthracene (for a blue emission), 9.10-bis(phenylethynlyl)anthracene (green) or 5,6,11,12-tetraphenylnapthacene (red). The fluorescer concentration is not critical and functions well in the range of 0.0002 M to 0.03 M, however the preferred concentration is between 0.001 M to 0.005 M.

The catalyst, by nature, is not consumed in the chemical reaction; therefore its concentration is not critical. However, the preferred list of catalysts include: amines, hydroxide, alkoxide, carboxylic acid salts and phenolic salts; whose conjugate acid salts have a pKa between 1 and 6 in aqueous solutions. Some of the preferred catalysts for this invention are: sodium salicylate, tetrabutylammonium salicylate, potassium salicylate, tetrahexylammonium benzoate, benzyltrimethylammonium m-chlorobenzoate, dimagnesium ethylenediamine tetracetate, tetraethyl ammonium stearate, calcium stearate, magnesium stearate, calcium hydroxide, magnesium hydroxide, lithium stearate, triethyl amine, pyridine, piperidine, imidazole, triethylene diamine and potassium trichlorophenoxide. For this invention, the preferred catalyst is sodium salicylate at a concentration less than 0.1 M and preferably 0.01 M.

The H₂O₂ concentration is not critical and can be found to vary anywhere from 0.01M to 10 M. The preferred H₂O₂ concentration for this invention is found to be approximately four times the oxalate concentration. Furthermore, production of the chemiluminescent reaction is not dependent on mixing order. Therefore, the chemical components can be separated into two or more parts to provide for a stable composition. Since the order of addition is not critical, the chemical components can be interchanged between parts inasmuch as the chemical components are solubilized and remain stable and in solution. One preferred configuration is to combine the oxalate and fluorescer components into the first part and the peroxide in the second part. Yet another preferred configuration is to combine the oxalate and fluorescer into the first part and the peroxide combined with a catalyst in the second part.

The choice of solvents for the chemiluminescent composition must be chosen to produce a stable composition and be miscible with the compressed, liquefied propellant. A wide variety of solvents meet these criteria and can be used in either the oxalate containing part, the peroxide containing part or the peroxide without catalyst containing part. Some solvents are suitable for any of the aforementioned parts, but the preferred solvents can be identified by each part. Some of the preferred solvents for the oxalate part include esters, such as: ethyl acetate, ethyl benzoate, dimethyl phthalate, dibutyl phthalate, diocytl phthalate, methyl formate, triacetin, diethyl oxalate or dioctyl terphthalate. Aromatic hydrocarbons, such as: benzene, toluene ethyl benzene, butylbenzene or chlorinated hydrocarbons, such as: chlorobenzene, orthodichlorobenzene, metadichlorobenzene, chloroform, carbon tetrachloride hexxachloroethane or tetrachlorotetrafluoropropane are suitable solvents however the use of these solvents can be limited by their toxicological or environmental properties. The preferred solvents for use in the oxalate part are dibutyl phthalate, dimethyl phthalate or ethyl benzoate.

The choice of solvents for the peroxide containing part is comprised from the list of primary, secondary or tertiary alcohols, such as: ethanol, methanol, hexanol, 2-ethylhexanol, 2-octanol, cyclohexanol, pinicol, glycerol, 1.3 propylene glycol, tertiary butanol and 3-methyl-3-pentanol; ethers, such as diethyl ether, diarnyl ether, tetrahydrofuran, dioxane, dibutyldiethyleneglycol, perfluropropyl ether or 1,2-dimethoxyethane; or esters such as; ethyl acetate, ethyl benzoate, dimethyl phthalate, dioctylphthalate or propyl formate. However, the preferred solvent for the peroxide containing part is tertiary butanol or 3-methyl-3-pentanol. Combinations of solvents are also suitable and effective in improving propellant compatibility.

Hydroxylic solvents, such as water, alcohols, such as ethanol or octanbl; or bases should not be used with the oxalate part, but are commonly found in the peroxide part. Hydrogen peroxide is rarely available as a 100% solution and the presence of water is found to stabilize the hydrogen peroxide and prevent auto-detonation prior to formulation.

Unlike the chemiluminescent aerosol spray and pump spray formulations, the chemiluminescent marking pen requires a different selection of solvents. For example, the solvent boiling point should be more than 120° C., so that the ink does not rapidly dry out in the pen. Also, any water present in the formulation should be salt-free so as to insure miscibility with the organic solvent. Alkylene carbonates and alkyl carbonates are preferred for the chemiluminescent pen marking formulation because their boiling point, at standard pressure is 200° C. and they have a vapor pressure of less than 0.05 mbar at 20° C. The alkyl and alkylene carbonates are also found to be smear-proof and rapidly penetrate the drawing material. Some of the preferred alkylene carbonate solvents for the chemiluminescent pen formulation include 1,3-dixolan-2-one, 4-methyl-1,3-dioxolan-2-one or propylene carbonate. Since alkylene carbonates are not miscible with water, mixtures of alkylene carbonate and alkyl carbonates are used to provide water miscibility.

(3) Spray Configuration

The chemical compositions may be prepared using any conventional means for solubilizing the components, such as the use of impellers, ultrasonics and elevated temperatures. The preferred embodiment is to prepare the individual chemiluminescent compositions, transfer the contents to a pressurizable container and then seal the container with the release valve in place. Once the vessel is sealed, it can be pressurized with the propellant gas or gas mixture directly through the valve to create a pressurized container.

Alternatively, the chemical compositions may be transferred into a vessel known as a two-component, hybrid or “bag in a can” type vessel; which contains a bladder, bag, diaphragm or separate container within the pressurizable vessel. Such a system is preferred for compositions; which are not compatible with the propellant gas or gas mixture. Propellants which do change their physical state, from liquid to gas once released to standard pressure, but do not form a single-phase pressurized mixture with the chemiluminescent composition often require such a system for producing a stable, pressurized ballistic aerosol composition.

In this embodiment, the bladder serves as a diaphragm to separate the composition from the propellant. However, the flexible nature of the bladder transfers the pressure generated from the propellant gas or gas mixture through the bladder, forcing the composition through the release valve. Once the bag or bladder is filled with the chemical composition and sealed, the canister is pressurized by injecting the propellant gas or gas mixture through a rubber gasket, rubber seal or one-way valve typically found in the bottom of the can.

The preferred method of embodiment consists of two or more suitable, pressurized vessels capable of releasing a ballistic aerosol spray. The specific elements of the invention are not critical provided that two-components can be co-dispensed in such a manner that the first component mixes with the second component either by means of a mixing chamber affixed to the actuator on each vessel or upon contact with the substrate or surface being use for night-time signal marking.

One preferred mixing chamber suitable for combining the chemiluminescent components from the separate pressurized aerosol cylinders is a Mixtek actuator, available from Mixtek Corporation (New York, N.Y.) as described in U.S. Pat No. 6,877,924.

Yet another commercially viable aerosol package suitable for simultaneously co-dispensing two chemiluminescent chemical components is described in U.S. Pat. No. 7,021,499, wherein the dispensing orifice is positioned distal from the second pressurized canister and the package comprises an integrally molded actuator body. In this embodiment, the first actuator releases the components from the first part and, by means of a cantilever, simultaneously triggers the second actuator also releasing the components from the second part.

The vessel material is not critical but preferably made from steel, aluminum or plastic, however any vessel material is suitable provided that a chemiluminescent, night-time signal marker can be ejected to a substrate or surface. The interior wall of the vessel can also be coated with an epoxy material such as epoxybisphenol-A-novolac, a tin (Sn) metal coating or some other coating suitable for preventing a chemical reaction of the composition with the interior of the container.

The pressure contained inside the vessel, is generally greater than 1 atmosphere and more preferably in the range of 20 to 100 pounds per square inch (PSI), and most preferably from 40 to 60 PSI. The preferred internal vessel pressure is about 50 PSI.

The preferred propellant of this invention is an inert hydrocarbon, which is a gas at standard temperature and pressure, but also a liquid under pressure. Several examples of suitable propellants for this invention include: dimethoxymethane, ethyl acetone, acetone, dimethyl ether, 2-methoxyethanol, 2-ethoxyethanol and butanol. One preferred propellant is dimethyl ether, however azeotropic mixtures of this and other propellants, such as carbon dioxide, nitrogen or air may also be used.

Another preferred propellant of this invention is known as 1,1,1,2-tetrafluoroethane (TFE-134), which is not only a gas at standard conditions and a liquid under pressure, but also forms a single-phase, homogeneous mixture with the chemiluminescent formulation. TFE-134 is also non-ozone-depleting propellant, which is miscible in the preferred solvents of this invention, namely; dibutylphthalate and tertiary butanol.

Yet another preferred method of co-dispensing two chemiluminescent components is by means of an aerosol pump spray. Such a system, commercially known as Versadial (U.S. Pat No. 7,222,752), is available in a binary interlocking configuration and which is compatible with a wide variety of chemiluminescent solvents, fluorescers and oxalate compositions. This finger-actuated chemiluminescent aerosol pump configuration is capable of producing the same alphanumeric signals as the propellant aerosol pump spray.

### EXAMPLES

The present invention is further described in detail by means of the following Examples and Comparisons. All parts and percentages are by weight and all temperatures are degrees Celsius unless explicitly stated otherwise.

### Example 1

A reusable, blue aerosol spray chemiluminescent marker formulation was prepared by combining 5.42 grams of bis(2-carbopentyloxy-3,5,6-trichlorophenyl)oxalate (CPPO) and 0.059 grams of 9,10-diphenylanthracene into 80 grams of dibutylphthalate solvent. The mixture, designated as part A, was sonicated for 10 minutes to facilitate dissolution. The contents were decanted from the mixing vessel into a 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, N.Y.). The sealed aerosol container and valve combination were injected with 6.5 grams of 1,1,1,2-tetrafluoroethane (TFE-134) through the valve stem to a pressure of about 50 pounds per square inch (psi). A separate mixture, designated part B was prepared by adding 2.91 grams of 35% hydrogen peroxide and 0.016 grams of sodium salicylate to a mixture of 64 grams of dibutyl phthalate and 16 grams of tertiary butanol. The contents were decanted from the mixing vessel into a separate 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, N.Y.) and injected with 6.5 grams of 1,1,1,2-tetrafluoroethane (TFE-134) through the valve stem to a pressure of about 50 pounds per square inch (psi). The filled and pressurized aerosol cylindrical containers, parts A and part B, were affixed together in parallel with plastic snap-on fittings. The valve outlet of part A was attached to the valve outlet of part B using a Mixtek actuator, available from Mixtek Corporation (New York, N.Y.) as described in U.S. Pat No. 6,877,924.

### Example 2

A viscous blue, chemiluminescent aerosol spray formulation, having a viscosity of approximately 100 centipoise (cps), was prepared by combining 5.20 grams of bis(2-carbopentyloxy-3,5,6-trichlorophenyl) oxalate (CPPO) and 0.057 grams of 9,10-diphenylanthracene and 3.2 grams of polyhydroxystyrene into 80 grams of dibutylphthalate solvent. The mixture, designated as part A, was sonicated for 10 minutes to facilitate dissolution. The contents were decanted from the mixing vessel into a 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, N.Y.). The sealed aerosol container and valve combination were injected with 6.5 grams of 1,1,1,2-tetrafluoroethane (TFE-134) through the valve stem to a pressure of about 50 pounds per square inch (psi). A separate mixture, designated part B was prepared by adding 2.80 grams of 35% hydrogen peroxide, 0.015 grams of sodium salicylate and 3.2 grams of polyhydroxystyrene to a mixture of 64 grams of dibutyl phthalate and 16 grams of tertiary butanol. The contents were decanted from the mixing vessel into a separate 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, New York) and injected with 6.5 grams of 1,1,1,2-tetrafluoroethane (TFE-134) through the valve stem to a pressure of about 50 pounds per square inch (psi). The filled and pressurized aerosol cylindrical containers, parts A and part B, were affixed together in parallel with plastic snap-on fittings. The valve outlet of part A was attached to the valve outlet of part B using a Mixtek actuator, available from Mixtek Corporation (New York, N.Y.) as described in U.S. Pat No. 6,877,924.

### Example 3

A yellow foamable resinous, chemiluminescent aerosol spray formulation was prepared by combining 5.20 grams of bis(2-carbopentyloxy-3,5,6-trichlorophenyl)oxalate (CPPO), 0.057 grams of 1-chloro 9,10-bis(phenyethynyl)anthracene and 9.60 grams of isobutyl methacrylate into 80 grams of dibutylphthalate solvent. The mixture, designated as part A, was sonicated for 10 minutes to facilitate dissolution. The contents were decanted from the mixing vessel into a separate 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, N.Y.). The sealed aerosol container and valve combination were injected with 6.5 grams of dimethyl ether (DME) through the valve stem to a pressure of about 50 pounds per square inch (psi). In a separate vessel, the part B was prepared by adding 2.80 grams of 35% hydrogen peroxide, 0.015 grams of sodium salicylate and 9.6 grams of isobutyl methacrylate to a mixture of 64 grams of dibutyl phthalate and 16 grams of tertiary butanol. The contents of the part B mixture were decanted from the mixing vessel into a separate 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, N.Y.) and injected with 6.5 grams of dimethyl ether (DME) through the valve stem to a pressure of about 50 pounds per square inch (psi). The filled and pressurized aerosol container part A and part B, were affixed together in parallel with plastic fittings and the valve of par A was attached to the valve of part B using a Mixtek actuator (available from Mixtek technologies) as described in U.S. Pat No. 6,877,924.

### Example 4

A reusable, yellow chemiluminescent aerosol spray marker formulation, with the catalyst in part A, was prepared by combining 5.42 grams of bis(2-carbopentyloxy-3,5,6-trichlorophenyl)oxalate (CPPO) and 0.059 grams of 1-chloro-9,10-bis(phenyethynyl)anthracene and 0.016 grams of sodium salicylate into 80 grams of dibutylphthalate solvent. The mixture, designated as part A, was sonicated for 10 minutes to facilitate dissolution. The contents were decanted from the mixing vessel into a separate 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, N.Y.). The sealed aerosol container and valve combination were injected with 6.5 grams of 1,1,1,2-tetrafluoroethane (TFE-134) through the valve stem to a pressure of about 50 pounds per square inch (psi). In a separate vessel, part B was prepared by adding 2.91 grams of 35% hydrogen peroxide to a mixture of 64 grams of dibutyl phthalate and 16 grams of tertiary butanol. The contents of the part B mixture were decanted from the mixing vessel into a separate 30×160 mm aluminum aerosol cylinder, sealed with an aluminum mounting cup containing a butyl rubber gasket, a nylon tilt valve and a Teflon (PTFE) dip tube manufactured by Precision Valve Corporation (Yonkers, N.Y.) and injected with 6.5 grams of 1,1,1,2-tetrafluoroethane (TFE-134) through the valve stem to a pressure of about 50 pounds per square inch (psi). The filled and pressurized aerosol container part A and part B, were affixed together in parallel with plastic fittings and the valve of par A was attached to the valve of part B using a Mixtek actuator (available from Mixtek technologies) as described in U.S. Pat No. 6,877,924.

### Example 5

A reusable, bag on valve, blue aerosol spray chemiluminescent marker formulation was prepared by combining 5.42 grams of bis(2-carbopentyloxy-3,5,6-trichlorophenyl)oxalate (CPPO) and 0.059 grams of 9,10-diphenylanthracene into 80 grams of dibutylphthalate solvent. The mixture, designated as part A, was sonicated for 10 minutes to facilitate dissolution. The contents were decanted from the mixing-vessel into a 30×160 mm aluminum aerosol cylinder, sealed with an aluminum bag on valve mounting cup containing a butyl rubber gasket, a nylon tilt valve and a Teflon (PTFE) dip tube manufactured by Precision Valve Corporation (Yonkers, N.Y.). The sealed aerosol container and valve combination were injected with 6.5 grams of 1,1,1,2-tetrafluoroethane (TFE-134) through the valve stem to a pressure of about 50 pounds per square inch (psi). A separate mixture, designated part B was prepared by adding 2.91 grams of 35% hydrogen peroxide and 0.016 grams of sodium salicylate to a mixture of 64 grams of dibutyl phthalate and 16 grams of tertiary butanol. The contents were decanted from the mixing vessel into a separate 30×160 mm aluminum aerosol cylinder, sealed with an aluminum bag on valve mounting cup containing a butyl rubber gasket, a nylon tilt valve and a Teflon (PTFE) dip tube manufactured by Precision Valve Corporation (Yonkers, N.Y.) and injected with 6.5 grams of 1,1,1,2-tetrafluoroethane (TFE-134) through the valve stem to a pressure of about 50 pounds per square inch (psi). The filled and pressurized aerosol cylindrical containers, parts A and part B, were affixed together in parallel with plastic snap-on fittings. The valve outlet of part A was attached to the valve outlet of part B using a Mixtek actuator, available from Mixtek Corporation (New York, N.Y.) as described in U.S. Pat No. 6,877,924.

### Example 6

A reusable, non-flammable, aerosol pump spray chemiluminescent marker formulation was prepared by combining 0.32 grams of sodium carbonate, 0.016 grams of 3-aminophthalhydrazide, 1.92 grams of sodium bicarbonate, 0.040 grams of ammonium carbonate monohydrate and 0.032 grams of copper sulfate pentahydrate to 78.4 grams of deionized water. The combined ingredients, designated as part A, were mixed for 10 minutes at room temperature and the contents were decanted from the mixing vessel into a 50 ml HDPE interlocking container manufactured by L'Oreal, Paris France and distributed by Versadial, New York, N.Y.). In a separate vessel, designated part B, 4 grams of 3% hydrogen peroxide were added to 76 grams of deionized water, mixed for 10 minutes and decanted into a second interlocking Versadial 50 ml HDPE container. To each container, a polypropylene dip tube, actuator valve, rubber seal, and volumetric pump were added and a sealed using a 42×40 mm dual dispensing and mixing volumetric pump as described in U.S. Pat No. 7,222,752.

### Example 7

A reusable, non-flammable, aerosol pump spray containing a viscous chemiluminescent marker formulation was prepared by combining 0.32 grams of sodium carbonate, 0.016 grams of 3-aminophthalhydrazide, 1.92 grams of sodium bicarbonate, 0.040 grams of ammonium carbonate monohydrate, 0.032 grams of copper sulfate pentahydrate and 2.0 grams of carboxymethylcellulose to 76.4 grams of deionized water. The combined ingredients, designated as part A, were mixed for 10 minutes at room temperature and the contents were decanted from the mixing vessel into a 50 ml HDPE interlocking container manufactured by L'Oreal, Paris France and distributed by Versadial, New York, N.Y.). In a separate vessel, designated part B, 4 grams of 3% hydrogen peroxide were added to 76 grams of deionized water, mixed for 10 minutes and decanted into a second interlocking Versadial 50 ml HDPE container. To each container, a polypropylene dip tube, actuator valve, rubber seal, and volumetric pump were added and a sealed using a 42×40 mm dual dispensing and mixing volumetric pump as described in U.S. Pat No. 7,222,752.

What I claim is:

1. A reusable chemiluminescent device, comprising:
a plurality of non-frangible chambers, separately disposed and each comprising a chemiluminescent component and further comprising flow passages in communication with said non-frangible chambers disposed to simultaneously dispense said chemiluminescent component from said plurality of non-frangible chambers wherein said device is disposed to create a chemiluminescent mixture designed for marking a surface; and,
a dispensing mechanism.

2. The device according to claim 1 wherein said plurality of non-frangible chambers comprises two non-frangible chambers.

3. The device according to claim 2, wherein said two non-frangible chambers are sealed and pressurized to at least atmospheric pressure; and the release of the said at least one valve simultaneously dispenses said fluorescer fluid and said activator fluids in a fine spray, initiating the chemiluminescent reaction and creating a chemiluminous mixture.

4. The device according to claim 1 further comprising at least one valve disposed to control a flow out of the said container.

5. The device according to claim 3, wherein said at least one valve further comprises two valves disposed to control the flow out of the said container.

6. The device according to claim 1, wherein a polymeric resin is added to said chemiluminous mixture to increase viscosity of the mixture.

7. The device according to claim 1, wherein said chemiluminous mixture is non-flammable and biodegradable.

8. The device according to claim 1, wherein said dispensing mechanism comprises a felt-tip pen apparatus.

9. The device according to claim 1, wherein at least one of said non-frangible chambers comprises a flexible bladder mechanism.

10. The device according to claim 1, wherein said chambers are unsealed and resealed to refill said chemiluminous fluorescer fluid and said activator fluids.

11. The device according to claim 1, wherein said fluorescer fluid is comprised of fluorescer dye and an oxalate; and said activator fluid is comprised of peroxide.

12. The device according to claim 1, wherein said fluorescer fluid is comprised of fluorescer dye and an oxalate and said activator fluid is comprised of peroxide and a catalyst.

13. The device according to claim 1, wherein said fluorescer fluid is comprised of fluorescer dye, an oxalate, and a polymeric resin and said activator fluid is comprised of hydrogen peroxide and a catalyst.

14. The device according to claim 1, wherein the said fluorescer fluid is comprised of 9,10-diphenylanthrancene fluorescer dye, which produces blue light chemiluminescent emission.

15. The device according to claim 1, wherein the said fluorescer fluid is comprised of 1-chloro-9,10-bis(phenyethynyl)anthracene fluorescer dye, which produces yellow light chemiluminescent emission.

16. The device according to claim 1, wherein the said fluorescer fluid is comprised of a combination of 9,20-diphenylanthrancene and 1-chloro-9,10-bis(phenyethynyl)anthracene fluorescer dyes, which produces near-white light chemiluminescent emission.

17. The device according to claim 1, wherein the said fluorescer fluid is comprised of 16,17-dideceloxyviolanthrone fluorescer dye, which produces infrared light emission, with peak of 790 nm.

18. A method of applying chemiluminescent markings onto a surface, comprising the steps of:
preparing a fluorescent fluid by combining a fluorescent dye, oxalate and a solvent;
preparing an activator fluid by combining hydrogen peroxide, a catalyst and a solvent;
transferring said fluorescent fluid into a first sealable chamber of a multi-chamber dispenser;
sealing said first sealable chamber;
transferring said activator fluid into a second sealable chamber of said multi-chamber dispenser and second sealable chamber; and,
dispersing said fluorescent fluid and activator fluid simultaneously onto a surface.

19. A method of applying chemiluminescent markings onto a surface comprising the steps of:
preparing a fluorescent solution comprising a fluorescent dye, an oxalate, a polymer resin, and a solvent;
preparing an activator fluid comprising a solution of hydrogen peroxide, a catalyst and a solvent;
transferring the fluorescent solution into a multi-chamber dispenser retaining said fluorescent solution in a first sealable chamber of said multi-chamber dispenser and sealing first sealable chamber of said multi-chamber dispenser;
transferring the activator fluid into a second sealable chamber of said multi-chamber dispenser and sealing said second sealable chamber of said multi-chamber dispenser; and,
dispensing, in a simultaneous manner, a mixture of said fluorescent solution and said activator fluid through a mixing portion of said multi-chamber dispenser to dispense the fluorescent and activator fluids onto a surface.
